(19) United States
(12) Patent Application Publication
(10) Pub. No.: US 2017/0195470 A1
(43) Pub. Date: Jul. 6, 2017

(54) ENCRYPTED WIRELESS SYSTEM WITH NFC FUNCTION

(71) Applicant: ADVANCED-CONNECTEK INC., New Taipei City (TW)

(72) Inventors: Tsung-Lin Li, New Taipei City (TW); Fu-Ren Hsiao, New Taipei City (TW)

(21) Appl. No.: 15/349,470

(22) Filed: Nov. 11, 2016

(30) Foreign Application Priority Data
Dec. 30, 2015 (TW) 104144557

(51) Int. Cl. H04M 1/725; H04B 5/00; B60C 23/02; H04L 29/06; H04W 12/02; G07C 5/08; H04W 4/00; H04B 1/3822

(52) U.S. Cl. CPC H04M 1/7253; H04W 4/008; H04B 5/0031; H04B 5/0037; H04B 1/3822; H04W 4/005; H04L 63/0428; H04W 12/02; G07C 5/0816; B60C 23/02; H04L 2209/80

(57) ABSTRACT

An encrypted wireless system with NFC function includes a detection module, an electronic control unit (ECU), and a mobile device. When the mobile device having the first NFC sensing module is near to the ECU having the second NFC sensing module, the ECU can be connected to the mobile device to trigger the car accordingly. In addition, the encryption chip of the mobile device encrypts the sensing data of the car, and the encrypted data are reporting to the car maintenance workshop via the mobile device. Hence, when the car cannot be operated normally, the car maintenance workshop can be rapidly introduced to help the car user figure and address the problems. Accordingly, better user experiences can be provided regarding the car operation, the feedback mechanism for the service center, and the data transmission between the mobile device and the ECU or between the mobile device and other NFC devices.

### CROSS-REFERENCE TO RELATED APPLICATION

This non-provisional application claims priority under 35 U.S.C. §119(a) to Patent Application No. 104144557 in Taiwan, R.O.C. on Dec. 30, 2015, the entire contents of which are hereby incorporated by reference.

### FIELD OF THE INVENTION

The instant disclosure relates to a car feedback device, and more particular to an encrypted wireless system with NFC function.

### BACKGROUND

Along with advancements of electronic industries, various products in mobile device and car electronics are developed continuously. Nowadays, a mobile device (i.e., a smart phone) may include communication, entertainment, photographing, and navigation functions, so that the mobile device can be a useful tool for performing multifunction. Specifically, a mobile device with NFC (near-field communication) function may transmit data with other NFC devices, thus greatly improving usefulness, functionalities, and additional values of the mobile device. Furthermore, the NFC function of the mobile device facilitates the usage in safety payment, device connection, and identity recognition.

Currently, the peripherals of a car commonly includes an ECU (electronic control unit) for integrally managing car information and further showing parameters related to the car, e.g., car speed, oil quantity, electric quantity of the battery, temperature of the radiator, revolution, mileage, etc. The car information recorded in the ECU may be utilized for car management and maintenance.

However, the conventional mobile device is wiredly connected to the car for being charged or for transmitting information of multimedia to the ECU so that a display of the car displays the information of the multimedia. There is no additional function between the mobile device and the car. For example, a car user neither can obtain the driving information of the car through the mobile device nor can instantly feedback the driving information to a car maintenance workshop, resulting in an inconvenience to the car user.

### SUMMARY OF THE INVENTION

In view of these, an encrypted wireless system with NFC function capable of performing the communication among the mobile device, the car, and the maintenance workshop may be a critical issue for car design, or even may be a basic unit of most of the car in the future.

In view of this, an embodiment of the instant disclosure provides an encrypted wireless system with NFC function. The encrypted wireless system with NFC function comprises a detection module, an ECU (electronic control unit), and a mobile device. The detection module is for detecting sensing data of a car. The ECU is connected to the detection module to receive the sensing data. The ECU comprises a first NFC sensing module and a first information transmission module. The mobile device comprises a second NFC sensing module, a second information transmission module, and an encryption chip. The second NFC sensing module matches with the first NFC sensing module to trigger a connection between the mobile device and the ECU. The second information transmission module transceives the sensing data transmitted by the first information transmission module and transmitting information to the ECU. The encryption chip encrypts the sensing data and transmits encrypted sensing data to a remote host through the second information transmission module.

In one embodiment, the remote host is at a car maintenance workshop, and the remote host transmits determined information to the mobile device.

In one embodiment, the mobile device further comprises an App shown on a display of the mobile device, the App performs alert and control functions according to the determined information.

In one embodiment, the mobile device further comprises a storage unit storing the determined information.

In one embodiment, the first information transmission module comprises a near-field wireless transmission unit, the near-field wireless transmission unit is a Wi-Fi, a Bluetooth, or a ZigBee unit.

In one embodiment, the second information transmission module comprises a near-field wireless transmission unit, the near-field wireless transmission unit is a Wi-Fi, a Bluetooth, or a ZigBee unit.

In one embodiment, the second information transmission module comprises a remote wireless transmission unit, the remote wireless transmission unit is a Wi-Fi, a 3G, or an LTE unit.

In one embodiment, the mobile device further comprises an expansion module for connecting to a uSD card with NFC function or to a SIM card with NFC function.

In one embodiment, the mobile device further comprises a wireless charging module, and the ECU further comprises a wireless power supply module for supplying electricity to the wireless charging module.

In one embodiment, the detection module is a tire pressure sensor for sensing tire pressure of the car, a temperature sensor for sensing a temperature of an engine of the car, an electric quantity sensor for sensing an electric quantity of a battery of the car, or an oil quantity sensor for sensing oil consumption of the car.

Based on the above, when the mobile device having the first NFC sensing module is near to the ECU having the second NFC sensing module, a connection can be established between the ECU and the mobile device, so that the car can be triggered accordingly. In addition, the encryption chip of the mobile device encrypts the sensing data of the car, and the encrypted sensing data are reporting to the car maintenance workshop via the second information transmission module. Hence, when the car cannot be operated normally, the car maintenance workshop can be rapidly introduced to help the car user figure and address the problems. Accordingly, the car user can have better user experiences regarding the operation of the car, the feedback mechanism for the service center, and the data transmission between the mobile device and the ECU or between the mobile device and other NFC devices.

Detailed description of the characteristics and the advantages of the instant disclosure are shown in the following embodiments. The technical content and the implementation of the instant disclosure should be readily apparent to any person skilled in the art from the detailed description, and the purposes and the advantages of the instant disclosure should be readily understood by any person skilled in the art with reference to content, claims, and drawings in the instant disclosure.

### BRIEF DESCRIPTION OF THE DRAWINGS

The instant disclosure will become more fully understood from the detailed description given herein below for illustration only, and thus not limitative of the instant disclosure, wherein:

FIG. 1 illustrates a schematic view of an operation scheme of an encrypted wireless system with NFC function according to an exemplary embodiment of the instant disclosure;

FIG. 2 illustrates a block diagram of the encrypted wireless system with NFC function;

FIG. 3 illustrates a block diagram showing communication between a first information transmission module and a second information transmission module of the encrypted wireless system with NFC function and a remote host; and

FIG. 4 illustrates a block diagram of the encrypted wireless with functions in which a mobile device is adapted to perform storing function and to include an App.

### DETAILED DESCRIPTION

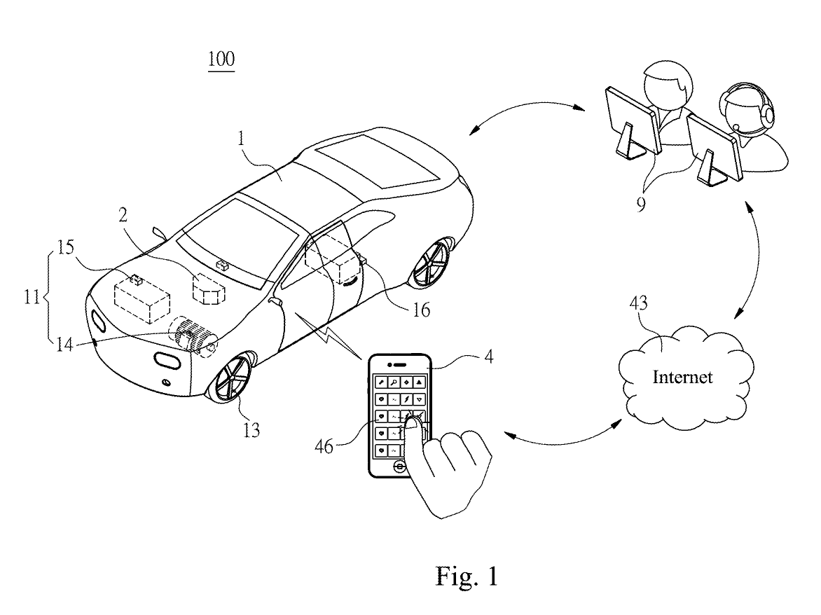

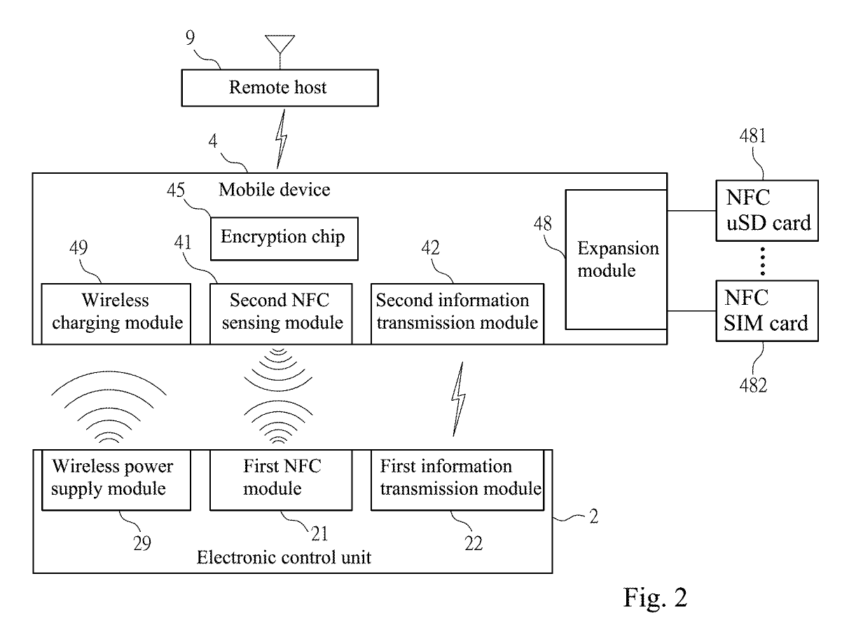

Please refer to FIGS. 1 and 2, illustrating an encrypted wireless system with near-field communication (hereinafter, abbreviated as NFC) function 100 of an exemplary embodiment of the instant disclosure. FIG. 1 illustrates a schematic view of an operation scheme of an encrypted wireless system with NFC function 100 according to an exemplary embodiment of the instant disclosure. FIG. 2 illustrates a block diagram of the encrypted wireless system with NFC function 100. The encrypted wireless system with NFC function 100 comprises a detection module 11, an electronic control unit 2 (hereinafter, abbreviated as ECU), and a mobile device 4.

Please refer to FIGS. 1 and 2. In this embodiment, the car 1 comprises the detection module 11 and the ECU 2 connected to the detection module 11. The detection module 11 may be a tire pressure sensor 13, a temperature sensor 14, an electric quantity sensor 15, or an oil quantity sensor 16. Alternatively, the detection module may be radars or other different kinds of sensor, which are widely utilized to subsystems of the engine, the chassis, and the car body.

Please refer to FIG. 1. In this embodiment, the tire pressure sensor 13 is for sensing the tire pressure of the car. When the tire pressure is insufficient or excessive, the tire pressure sensor 13 generates sensing data and transmits the sensing data to the ECU 2; that is, the sensing data of the car 1 detected by the detection module 11 is transmitted to the ECU 2, and then the ECU 2 transmits the sensing data to a remote host 9 of a car maintenance workshop (which may be a genuine workshop or an aftermarket workshop) through the mobile device 4. Hence, personnel in the workshop or the remote host 9 can determine if the car is operating abnormally, record the abnormal event, and provide assistance for a car user. In addition, the remote host 9 transmits the determined information (car state) to the mobile device 4, and the car user can check the determined information through the display of the mobile device 4, so that the car user can be instantly notified of the abnormal condition by the determined information. Accordingly, when the car 1 cannot operate normally, the car maintenance workshop can be introduced to address the problem or to guide the car user to figure out and address the problems, so that the problems of the car 1 can be solved quickly and the car user can drive the car 1 safely.

Please refer to FIG. 1. In this embodiment, the temperature sensor 14 is for sensing the temperature of the car engine. When the temperature of the car engine is too high, the temperature sensor 14 generates sensing data and transmits the sensing data to the ECU 2; that is, the sensing data of the car 1 detected by the detection module 11 is transmitted to the ECU 2, and then the ECU 2 transmits the sensing data to a remote host 9 of a car maintenance workshop (which may be a genuine workshop or an aftermarket workshop) through the mobile device 4. Hence, personnel in the workshop or the remote host 9 can determine if the car is operating abnormally, record the abnormal event, and provide assistance for a car user. In addition, the remote host 9 transmits determined information to the mobile device 4, and the car user can check the determined information through the display of the mobile device 4, so that the car user can be instantly notified of the abnormal condition by the determined information. Accordingly, when the car 1 cannot operate normally, the car maintenance workshop can be introduced to address the problem or to guide the car user to figure out and address the problems, so that the problems of the car 1 can be solved quickly and the car user can drive the car 1 safely.

Please refer to FIG. 1. In this embodiment, the electric quantity sensor 15 is for sensing the residual electric quantity of the battery of the car 1. When the residual electric quantity of the battery is too low, the electric quantity sensor 15 generates sensing data and transmits the sensing data to the ECU 2; that is, the sensing data of the car 1 detected by the detection module 11 is transmitted to the ECU 2, and then the ECU 2 transmits the sensing data to a remote host 9 of a car maintenance workshop (which may be a genuine workshop or an aftermarket workshop) through the mobile device 4. Hence, personnel in the workshop or the remote host 9 can determine if the car is operating abnormally, record the abnormal event, and provide assistance for a car user. In addition, the remote host 9 transmits determined information to the mobile device 4, and the car user can check the determined information through the display of the mobile device 4, so that the car user can be instantly notified of the abnormal condition by the determined information. Accordingly, when the car 1 cannot operate normally, the car maintenance workshop can be introduced to address the problem or to guide the car user to figure out and address the problems, so that the problems of the car 1 can be solved quickly and the car user can drive the car 1 safely. Such embodiment may be utilized in a hybrid car; e.g., when the residual electric power of the battery is too low, the car's engine can be instantly switched to be oil-driven for providing the car user a comfortable driving experience.

Please refer to FIG. 1. In this embodiment, the oil quantity sensor 16 is for sensing the residual oil quantity of the car 1. When the residual oil quantity is too low, the oil quantity sensor 16 generates sensing data and transmits the sensing data to the ECU 2; that is, the sensing data of the car 1 detected by the detection module 11 is transmitted to the ECU 2, and then the ECU 2 transmits the sensing data to a remote host 9 of a car maintenance workshop (which may be a genuine workshop or an aftermarket workshop) through the mobile device 4. Hence, personnel in the workshop can determine if the car is operating abnormally, record the abnormal event, and provide assistance for a car user. In addition, the remote host 9 transmits determined information to the mobile device 4, and the car user can check the determined information through the display of the mobile device 4, so that the car user can be instantly notified of the abnormal condition by the determined information. Accordingly, when the car 1 cannot operate normally, the car maintenance workshop can be introduced to address the problem or to guide the car user to figure out and address the problems, so that the problems of the car 1 can be solved quickly and the car user can drive the car 1 safely. Such embodiment may be utilized in a hybrid car; e.g., when the residual oil quantity is too low, the car's engine can be instantly switched to be electricity-driven for providing the car user a comfortable driving experience.

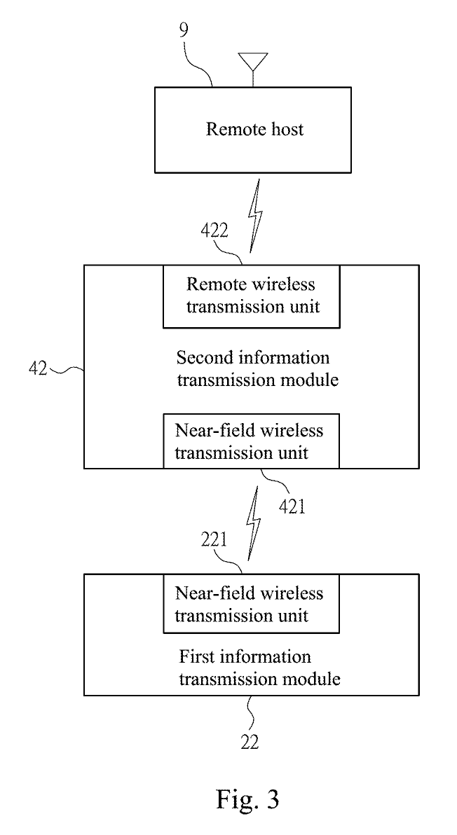

Please refer to FIGS. 1 to 3. FIG. 3 illustrates a block diagram showing communication between a first information transmission module and a second information transmission module of the encrypted wireless system with NFC function and a remote host. In this embodiment, the ECU 2 is connected to the detection module 11 to receive the sensing data. The ECU 2 comprises a first NFC sensing module 21 and a first information transmission module 22. The ECU 2 is connected to various components of the car 1 to receive the sense data. In this embodiment, the first NFC sensing module 21 is a near-field communication module, and the module can perform noncontact point-to-point data transmission. The first information transmission module 22 may be, but not limited to, a near-field wireless transmission unit 221 which utilizes wireless technologies, such as Wi-Fi, Bluetooth (BT), ZigBee (IEEE802.15.4), UWB (IEEE802.15.3a), or ANT+; that is, the near-field wireless transmission unit 221 may be a Wi-Fi, a Bluetooth, a ZigBee, a UWB, or an ANT+ unit.

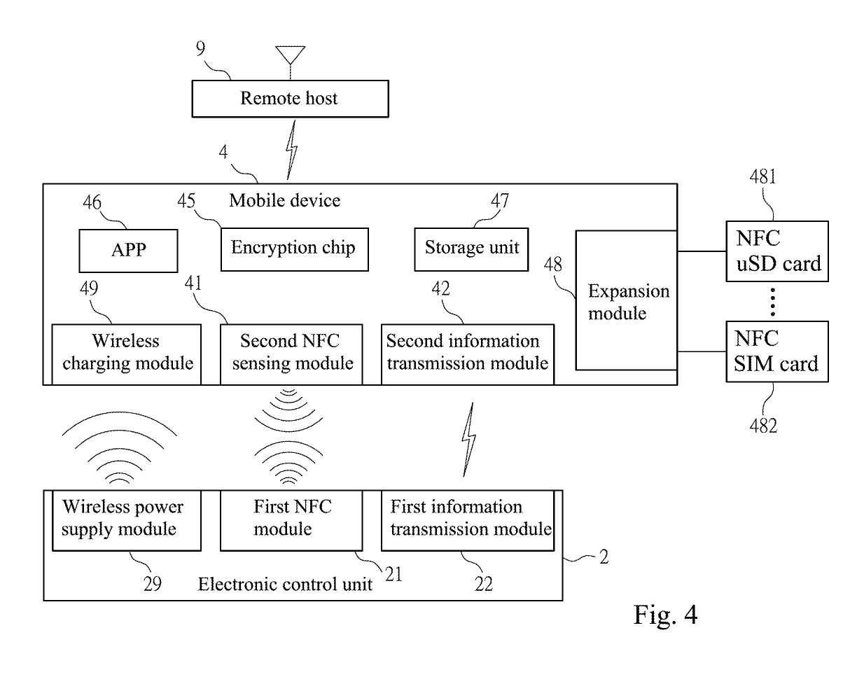

Please refer to FIGS. 1 to 4. FIG. 4 illustrates a block diagram of the encrypted wireless with function in which a mobile device is adapted to perform storing function and to include an App. The remote host 9 of the car maintenance workshop may be a driving service center, and personnel of the service center can compare the sensing data of the car 1 with that of a normal car so as to examine if the car 1 is in an abnormal condition. In addition, the remote host 9 can instantly transmit the operation states of the components of the car 1 to the mobile device 4. Hence, when the remote host 9 figures out that the car 1 is in the abnormal condition, the remote host 9 can provide service information regarding a nearby maintenance workshop to the car user via an App 46 and the GPS system of the mobile device 4, so that the service center can provide suitable and instant assistance to the car user.

Please refer to FIGS. 1 to 3. In this embodiment, the mobile device 4 may be a smart phone, a tablet computer, etc. The mobile device 4 comprises a second NFC sensing module 41, a second information transmission module 42, and an encryption chip 45. In this embodiment, the second NFC sensing module 41 is a near-field communication module, and the module can perform noncontact point-to-point data transmission. The second NFC sensing module 41 matches with the first NFC sensing module 21 to trigger a connection between the mobile device 4 and the ECU 2; namely, after the matching (verification) is done, the car 1 can be triggered to allow the data transmission, e.g., the sensing data, between the mobile device 4 and the ECU 2.

Please refer to FIGS. 1 to 3. In this embodiment, in the occasion of connecting the mobile device 4 with the ECU 2, the mobile device 4 may be placed on the instrument panel of the car 1 which is near to the ECU 2, so that the distance between the first NFC sensing module 21 and the second NFC sensing module 41 is within an available distance to allow the matching between the NFC modules. Alternatively, upon the connection, the mobile device 4 may be outside of the car 1 and just near the car 1, as shown in FIG. 1. Moreover, when the mobile device 4 is within the available distance respect to the ECU 2, a connection notification may be automatically shown on the mobile device 4, and the car user can simply tap the notification shown on the display of the mobile device 4 to build the connection for transmitting multimedia like music, videos, etc., or for transmitting the driving path set by the navigation program of the mobile device 4 to the ECU 2.

Please refer to FIGS. 1 to 3. In this embodiment, the second information transmission module 42 of the mobile device 4 may be, but not limited to, a near-field wireless transmission unit 421 which utilizes wireless technologies, such as Wi-Fi, Bluetooth (BT), ZigBee, or ANT+; that is, the near-field wireless transmission unit 421 may be a Wi-Fi, a Bluetooth (BT), a ZigBee (IEEE802.15.4), or an ANT+ unit. The second information transmission module 42 transceives (i.e., receives and/or sends) the sensing data transmitted by the first information transmission module 22. In addition, the connection between the ECU 2 and the mobile device 4 may be approached wiredly, e.g., via an RS232 interface or a USB interface.

Please refer to FIGS. 1 to 3. In this embodiment, the second information transmission module 42 further comprises a remote wireless transmission unit 422 which may be a Wi-Fi, a 3G, or an LTE unit. The remote wireless transmission unit 422 performs the transmission via Internet 43, GSM network, WiMAX, wireless LAN, LAN, or Phone line. The second information transmission module 42 transmits the encrypted sensing data encrypted by the encryption chip 45 to the remote host 9 of the car maintenance workshop via the remote wireless transmission unit 422.

Please refer to FIGS. 1 and 2. In this embodiment, the encryption chip 45 (namely, a security element) is assembled on the circuit board of the mobile device 4, and the encryption chip 45 is an NFC-SE-IC chip. Accordingly, the security level of the transmission can be elevated by the data encryption. It is understood that, in the case that the mobile device 4 is provided with the NFC-SE-IC chip, an SD card with SE or an SIM card with SE may be utilized by the mobile device 4.

Please refer to FIGS. 1 and 4. In this embodiment, the mobile device 4 further comprises an App 46 shown on the display of the mobile device 4. When the mobile device 4 receives the determined information, the App 46 automatically generates alert light or sounds. On the other hand, the alert notification shown on the mobile device 4 may be turned off via the App 46. In addition, the App 46 may be applied to set preferences regarding the notification and to establish a feedback mechanism between the mobile device 4 and the remote host 9 so as to perform a control function. That is, the App 46 may be applied to adjust the default values of the sensing data in the ECU 2 according to a practical condition of the car or according to the professional determination of the car user himself or herself. Therefore, the ECU 2 can be operated in a flexible manner. Moreover, the App 46 may be applied to report the car condition to the car maintenance workshop or update the default values of the sensing data in the ECU 2 from the workshop end.

The NFC-SE-IC chip of the mobile device 4 may be used with Apps supporting NFC function. Hence, the mobile device 4 may be provided as not only an NFC tag but also an NFC reader by electronic certification technology. Therefore, the mobile device 4 can receive and send (transmit in dual directions) information and data quickly. Moreover, the mobile device 4 can read other tags with NFC function or transmit data between other NFC devices. For example, if the NFC device is an electronic lock with NFC function, the mobile device 4 with NFC function can be used with a certain App provided by, such as, the lock manufacturer. After the mobile device 4 is authorized by the lock manufacturer through the certain app, the mobile device 4 can unlock the electronic lock without cards or keys. Therefore, the user can unlock the car door and trigger the car 1 conveniently.

Please refer to FIGS. 1 to 4. In this embodiment, the mobile device 4 further comprises a storage unit 47. The storage unit 47 may be a memory built in the circuit board of the mobile device 4. The storage unit 4 is for storing the determined information. In addition, the mobile device 4 further comprises an expansion module 48. The expansion module 48 may be a receptacle connected to the circuit board, and the expansion module 48 is for connecting to a uSD card 481 or an SIM card 482. Specifically, the uSD card 481 is an SD card with NFC function and the SD card 481 utilizes universal mobile telecommunications system (UMTS) technology; the SIM card 482 is with NFC function.

Please refer to FIG. 1. In this embodiment, the mobile device 4 may further comprise a wireless charging module 49, and the ECU 2 may further comprise a wireless power supply module 29 for supplying electricity to the wireless charging module 49. Accordingly, with the wireless charging technology, the electricity of the car 1 can be provided for the mobile device 4.

Based on the above, when the mobile device having the first NFC sensing module is near to the ECU having the second NFC sensing module, a connection can be established between the ECU and the mobile device, so that the car can be triggered accordingly. In addition, the encryption chip of the mobile device encrypts the sensing data of the car, and the encrypted sensing data are reporting to the car maintenance workshop via the second information transmission module. Hence, when the car cannot be operated normally, the car maintenance workshop can be rapidly introduced to help the car user figure and address the problems. Accordingly, the car user can have better user experiences regarding the operation of the car, the feedback mechanism for the service center, and the data transmission between the mobile device and the ECU or between the mobile device and other NFC devices.

While the instant disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. An encrypted wireless system with NFC function, comprising:
a detection module for detecting sensing data of a car;
an ECU connected to the detection module to receive the sensing data, wherein the ECU comprises a first NFC sensing module and a first information transmission module; and
a mobile device, comprising:
a second NFC sensing module matching with the first NFC sensing module to trigger a connection between the mobile device and the ECU;
a second information transmission module, transceiving the sensing data transmitted by the first information transmission module and transmitting information to the ECU; and
an encryption chip encrypting the sensing data and sending encrypted sensing data to a remote host through the second information transmission module.

2. The encrypted wireless system with NFC function according to claim 1, wherein the remote host is at a car maintenance workshop, the remote host transmits determined information to the mobile device.

3. The encrypted wireless system with NFC function according to claim 2, wherein the mobile device further comprises an App shown on a display of the mobile device, the App performs alert and control functions according to the determined information.

4. The encrypted wireless system with NFC function according to claim 1, wherein the mobile device further comprises a storage unit storing the determined information.

5. The encrypted wireless system with NFC function according to claim 2, wherein the first information transmission module comprises a near-field wireless transmission unit, the near-field wireless transmission unit is a Wi-Fi, a Bluetooth, or a ZigBee unit.

6. The encrypted wireless system with NFC function according to claim 2, wherein the second information transmission module comprises a near-field wireless transmission unit, the near-field wireless transmission unit is a Wi-Fi, a Bluetooth, or a ZigBee unit.

7. The encrypted wireless system with NFC function according to claim 2, wherein the second information transmission module comprises a remote wireless transmission unit, the remote wireless transmission unit is a Wi-Fi, a 3G, or an LTE unit.

8. The encrypted wireless system with NFC function according to claim 2, wherein the mobile device further comprises an expansion module for connecting to a uSD card with NFC function or to a SIM card with NFC function.

9. The encrypted wireless system with NFC function according to claim 1, wherein the mobile device further comprises a wireless charging module, and wherein the ECU further comprises a wireless power supply module for supplying electricity to the wireless charging module.

10. The encrypted wireless system with NFC function according to claim 1, wherein the detection module is a tire pressure sensor for sensing tire pressure of the car, a temperature sensor for sensing a temperature of an engine of the car, an electric quantity sensor for sensing an electric quantity of a battery of the car, or an oil quantity sensor for sensing oil consumption of the car.
